(19) United States
(12) Patent Application Publication
(10) Pub. No.: US 2026/0084347 A1
(43) Pub. Date: Mar. 26, 2026

(54) PURIFICATION METHOD FOR PRODUCING A POLYOLEFIN REGENERATE

(71) Applicant: ALPLA WERKE ALWIN LEHNER GMBH & CO. KG, Hard (AT)

(72) Inventor: Michael HEYDE, Bergisch Gladbach (DE)

(21) Appl. No.: 18/863,732

(22) PCT Filed: May 10, 2023
(86) PCT No.: PCT/EP2023/062429

§ 371 Date: Nov. 7, 2024

(30) Foreign Application Priority Data
May 12, 2022 (CH) CH000568/2022
Sep. 22, 2022 (CH) CH001101/2022

(51) Int. Cl. B29B 17/02; B01D 61/58; B01D 69/02; B29B 9/06; B29K 23/00; B29K 105/26; C08J 11/06

(52) U.S. Cl. CPC B29B 17/02; B01D 61/58; B01D 69/02; C08J 11/06; B01D 2311/08; B01D 2325/20; B29B 9/06; B29B 2017/0293; B29K 2023/00; B29K 2105/26; C08J 2323/00

(57) ABSTRACT

A purification method for producing a polyolefin (PO) regenerate (r), including (a) mixing superficially cleaned PO waste (p), referred to as raw polymer (p), with solvent and dissolving the raw polymer (p) in the solvent, (b) recovering the purified polymer from the solvent, (c) preparing the solvent, (d) returning the solvent to step (a), (e) separating residues (e1, e2), and (f) extruding the purified PO regenerate (r) to form pellets (r). Step (c) is carried out using at least one membrane filter (c1).

### FIELD OF THE INVENTION

The invention relates to a purification method for producing a polyolefin (PO) regenerate according to the preamble of claim 1, and a method for recycling polyolefin waste according to the preamble of claim 11.

### PRIOR ART

Polyolefins (e.g. HDPE or PE) are widespread in the plastics market, in particular for use for packaging. It is therefore advisable to return the material in the sense of recycling. Polyolefins have the property of absorbing substances from the environment during their use. In subsequent uses of the polyolefin plastic as a recyclate, these substances can impair the quality, either because they can be released back into the filling material or, if they are more volatile, are perceived as a bad smell. Contamination in the polymer material impairs the quality of the recycled material. However, recycling methods have so far not been able to sufficiently remove these contaminants from the material in order, for example, to make a recyclate suitable for the packaging of food, medical products or high-quality cosmetic products available to the market in an economically viable manner.

Although common methods are economical, they can only inadequately or not at all remove very large contaminants with a molecular weight of approximately 400 to 800 Dalton, which can penetrate deep into the HDPE. From a molecular weight of 800 Dalton, the molecules are so inert that contaminants hardly migrate into the filling material. They therefore no longer pose a risk or burden for subsequent use.

In order to regenerate the solvent, it is known to use a membrane separation step to prepare the solvent. The function of the membrane separation step is to remove the solvent from the polymer matrix after the solid impurities have been separated by means of a decanter. With the decanter, solid impurities are separated from the continuous phase which consists of solvent and polymer. The membrane separation step separates solvent from polymer to recover the polymer. As the polymer concentration increases, the viscosity of the mixture increases, which reduces the permeation performance.

The problem has been partially solved by allowing only very tightly controlled input materials from selected previous applications. However, this selective choice is very limiting, as many separate recycling streams would be necessary. Furthermore, it does not solve the problem of potential contamination from improper use.

One solution approach is based on a solvent method which frees the polymer from its contaminants by dissolving the polymer and selectively precipitating it. Another solution approach involves separating the contaminants by swelling the polymer with solvent and then squeezing out the polymer.

However, both methods require a large amount of solvent. Furthermore, the preparation of the solvent by energy-intensive evaporation is economically and ecologically questionable. In both methods, a solvent-contaminated polymer remains which must be freed from residual solvent by a drying step. The contaminants dissolved in this residual amount of solvent remain in the polymer during drying.

### OBJECT OF THE INVENTION

The disadvantages of the described prior art result in the object of economically and ecologically improving the removal of contaminants with a molecular weight between approximately 400 and 800 Dalton in a polyolefin recycling method.

### DESCRIPTION

In the case of a purification method for the production of a polyolefin (PO) regenerate, the stated object is achieved by the features set out in the characterizing part of claim 1. The dependent claims relate to developments and/or advantageous alternative embodiments.

The invention is preferably characterized in that the solvent and the raw polymer dissolved therein are fed to a membrane filter and are separated in the membrane filter into a solvent-containing retentate and a solvent-containing permeate. This makes the present method extremely energy-efficient since less solvent is required to be regenerated to free the raw polymer from contamination and no large quantities of loaded solvent have to be distilled. The heat energy to be used can be significantly reduced in the present method. The dissolved polymer is separated by the membrane filter into a permeate which consists of solvent and low molecular weight components of the polymer, and a retentate which consists of solvent and higher molecular components of the polymer. The low molecular components contain the contaminants to be separated which can be discarded with the solvent if necessary. The higher molecular components represent the target product. Since the permeate also contains low molecular components in addition to the solvent, the method according to the invention has a good permeation performance. The permeability of the membrane is provided in such a way that low molecular components, which also include contaminants to be removed, are part of the permeate and are not retained by the membrane. According to the prior art, the function of the membrane filter is to remove the solvent from the polymer matrix after the solid impurities have been separated by means of a decanter. The separation task accomplished in the prior art is therefore a different one than the present invention: with the decanter, solid impurities are separated from the continuous phase, which phase consists of solvent and polymer. The membrane separation process separates the solvent from the polymer in order to recover the polymer. However, contaminants that have penetrated deep into the polymer matrix still remain in the retentate.

It has proven to be expedient if all components with a molecular weight <2000 Dalton, preferably <1000 Dalton and particularly preferably <800 Dalton are separated as permeate in the first membrane filter. As a result, only components whose molecules are so inert that the contaminants hardly migrate into the filling material of the recycled containers remain in the raw polymer. In addition, the vapor pressure of these large molecules is low so that they are no longer perceptible as an odor. Polymer components that are separated and not considered contaminants can be replenished by re-additivation after purification is complete, provided they are relevant for the functional properties of the polymer.

The invention is also preferably characterized in that the solvent with contaminants having a molecular weight of substantially <400 Dalton, preferably <200 Dalton, is separated from the solvent with contaminants of substantially >400 Dalton, preferably >200 Dalton, using a second membrane filter. This allows the solvent to be further regenerated or purified without the need for thermal energy. The number of membrane filters or filtration stages and thus the employed filter area as well as the associated costs for each stage are in competition with the energy costs, in particular the thermal energy costs, for the selective distillation on boiling plates in order to treat the solvent. Therefore, the present purification method is not limited to 2 membrane filters; instead, the number of employed membrane filters depends on the required degree of purity of the PO regenerate and the energy requirement.

In a further preferred embodiment of the invention, the polymer solution which has been purified of all components preferably with a molecular weight <=2000 Dalton, preferably <=1000 Dalton and particularly preferably <=800 Dalton, is separated after the first membrane filter as retentate in a first evaporator into the PO regenerate with solvent residues and a first prepared solvent, whereby method step (b) is realized. This results in a highly pure PO regenerate which contains only small amounts of solvent residues. Instead of the first evaporator, it would also be conceivable to use a further membrane filter to separate the PO regenerate (the target product) from the solvent.

In yet another preferred embodiment of the invention, the solvent with contaminants of substantially >400 Dalton, preferably >200 Dalton, is separated in a second evaporator into a first residue and a second prepared solvent. This allows almost all of the solvent to be regenerated and recycled. The separated contaminants can be disposed of separately.

Since the first and second prepared solvents are recycled into the mixing step in a first and second return, almost all of the solvent can be reused, and its losses are minimal in the present purification method.

It is advantageous if a partial stream of the polymer solution after the first membrane filter is returned to the mixing step as a thick solution. By the degree of return of the thick solution, the residual contamination in the plastics pellets of substances in the MW range of 400-800 Dalton, preferably 200-800 Dalton, can be controlled.

It is also advantageous if a partial stream of the solvent with contaminants with a molecular weight of substantially <400 Dalton and preferably >200 Dalton is returned to the mixing step as a thin solution after the second membrane filter. By the degree of return of the thin solution, the proportion of contaminants in the MW range of <400 Dalton, preferably >200 Dalton, in the PO regenerate can be controlled.

In a further particularly preferred embodiment, the degree of return of the thick solution and thin solution returned to the mixing step is controlled via a first valve and a second valve. This makes it easy to adjust or control the proportion of substances in the range of a MW of <400 Dalton and in the range of a MW of 400-800 or 200-800 Dalton.

It proves advantageous if the extrusion step is carried out in a vacuum extruder, and the solvent residues are separated from the PO regenerate as a second residue in the vacuum extruder by degassing. This allows the removal of any remaining contaminants with a MW <400 Dalton or <200 Dalton from the PO regenerate.

Another aspect of the invention relates to a method for recycling polyolefin waste by producing PO regenerates which comprises the purification method described above. This allows a complete recycling method to be carried out in a particularly energy-efficient manner. The polyolefins are fed into the recycling process in the form of post-consumer sorting fractions with all typical impurities on and in the polyolefin material. The fractions can be, for example, HDPE “rigid” bottle goods or “flexible” film goods, but can also consist of the polymers PP, LDPE or a mixed polyolefin fraction. In addition, there are sorting fractions according to color and size.

Advantageously, the mechanical purification of the waste is carried out before the waste washing or vice versa, or the two method steps are carried out simultaneously. This depends on the returned waste, in order to clean its surface as efficiently as possible.

Further advantages and features can be found in the following description of three embodiments of the invention with reference to the schematic drawings. In the figures, in a representation that is not to scale:

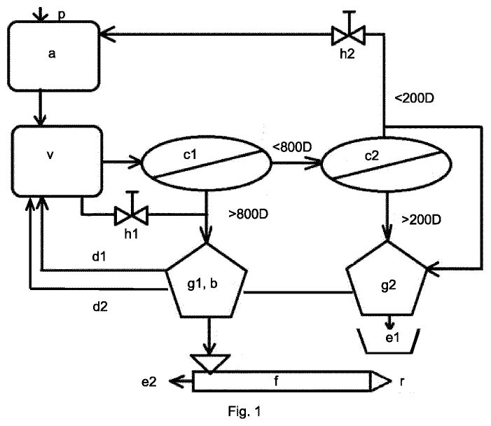

FIG. 1: is a flow chart showing a purification method for producing a PO regenerate.

FIG. 1 shows an improved purification method for producing a PO regenerate. The superficially cleaned polymer which comes from waste recycling, hereinafter referred to as raw polymer, is fed to the dissolving and membrane process and mixed with the solvent in a stirred tank a. The raw polymer-already in solution-enters a temperature-controlled receiver v and is fed from there to a first membrane filter c1 which separates the solution into a first partial stream (permeate: fluid which penetrates the membrane filter c1) with dissolved components with a molecular weight (MW) of <800 Dalton and into a second partial stream (retentate: fluid which is retained by the membrane filter c1) with a molecular weight of >800 Dalton. The dissolved raw polymer is therefore separated by means of the membrane filter (c1) into a permeate that consists of solvent and dissolved low molecular components, and a retentate that consists of solvent and dissolved higher molecular weight components.

The partial stream with a MW<800 Dalton is fed to a second membrane filter c2 which in turn separates it into a third partial stream with dissolved components in the molecular weight range of <400 Dalton, preferably <200 Dalton, and a fourth partial stream with a MW range of 400 Dalton to 800 Dalton or 200 to 800 Dalton.

The partial stream >800 D is partly returned to the receiver v and partly fed to a first evaporator g1; the mass ratio is adjustable by a valve h1.

The residue from the evaporator g1 then enters the vacuum extruder f. A second residue e2 is separated via the degassing of the extruder f, which residue contains all polymer components and contaminants of <400 Dalton, in the preferred embodiment <200 Dalton.

The partial stream with dissolved components in the molecular weight range of 400-800 D or 200-800 D is fed to the evaporator 2. The recovered solvent condensate is returned to the receiver v in a second return d2. The first residue e1 contains polymer components and the contaminants to be separated with a MW of 400 or 200 to 800 Dalton.

The partial stream with dissolved components with a MW of <400 Dalton or <200 Dalton, referred to as a “thin solution”, returns partly to the receiver v and partly to the second evaporator g2. The mass ratio can be adjusted by a second valve h2.

The product of the extruder f is the PO regenerate in the form of plastics pellets r, in which polymer components and other substances or contaminants in the molecular weight range 400 or 200-800 D are specifically depleted compared to the raw polymer.

The residual contamination in the plastics pellets r of substances in the MW range of 400 or 200-800 Dalton is determined by the recirculation rate of a “thick solution” into the receiver v, which is adjusted using a first valve h1.

The proportion of substances in the MW range <400 D or <200 D in the regenerate or plastics pellets fed to extrusion is determined by the recirculation rate of the thin solution into the receiver v, which is adjusted using a second valve h2 or is separated in the extruder vacuum as a second residue e2.

The energy-intensive distillation of the solvent for regeneration, which is unavoidable in purification methods according to the prior art, can be substituted in the present purification method. Instead, membrane filters can take over the preparation of the solvent.

Portions of the employed solvent separated via extruder degassing must be supplemented with fresh solvent (I) in the mixer (a).

### LIST OF REFERENCE SIGNS

a Stirred tank
v Receiver
b Recovery of the purified polymer
c1 First membrane filter
c2 Second membrane filter
d1 First return of the solvent
d2 Second return of the solvent
e1 First residue
e2 Second residue
f Vacuum extruder
g1 First evaporator
g2 Second evaporator
h1 First valve
h2 Second valve
p Raw polymer, PO waste
r PO regenerate, pellets
v Receiver

1.-12. (canceled)

13. A purification method for producing a polyolefin (PO) regenerate (r), comprising:
(a) mixing superficially cleaned PO waste (p), referred to as raw polymer (p), with solvent, and dissolving the raw polymer (p) in the solvent,
(b) recovering the purified polymer from the solvent,
(c) preparing the solvent,
(d) returning the solvent to step (a),
(e) separating residues (e1, e2), and
(f) extruding the purified PO regenerate (r) to form pellets (r),
wherein
the solvent and the raw polymer dissolved therein are fed to a membrane filter (c1) and separated in the membrane filter (c1) into a solvent-containing retentate and a solvent-containing permeate.

14. The purification method according to claim 13, wherein the first membrane filter (c1), all components with a molecular weight <2000 Dalton, are separated as permeate.

15. The purification method according to claim 13, wherein the solvent with contaminants having a molecular weight of substantially <400 Dalton is separated from the solvent with contaminants of substantially >400 Dalton using a second membrane filter (c2).

16. The purification method according claim 13, wherein the polymer solution which has been purified of all components preferably with a molecular weight <=2000 Dalton, is separated after the first membrane filter (c1) as retentate in a first evaporator (g1) into the PO regenerate with solvent residues and a first prepared solvent, as a result of which method step (b) is realized.

17. The purification method according to claim 13, wherein the solvent with contaminants of substantially >400 Dalton is separated in a second evaporator (g2) into a first residue (e1) and a second prepared solvent.

18. The purification method according to claim 17, wherein the first and second prepared solvents are recycled into the mixing step (a) in a first and second recycling (d1, d2).

19. The purification method according to claim 13, wherein a partial stream of the polymer solution after the first membrane filter (c1) is returned to the mixing step (a) as a thick solution.

20. The purification method according to claim 13, wherein a partial stream of the solvent with contaminants having a molecular weight of substantially <400 Dalton is returned to the mixing step (a) as a dilute solution after the second membrane filter (c2).

21. The purification method according to claim 20, wherein the degree of return of the thick solution and thin solution returned to the mixing step (a) is regulated via a first valve (h1) and a second valve (h2).

22. The purification method according to claim 13, wherein the extrusion step (f) is carried out in a vacuum extruder, and the solvent residues are separated from the PO regenerate (r) as a second residue (e2) in the vacuum extruder by degassing.

23. A method for recycling polyolefin waste, in which PO regenerates are produced, comprising:
(A) pre-sorting the waste,
(B) mechanically purifying the waste,
(C) washing the waste with a fluid, and
(D) producing the PO regenerates in a purification method using a solvent to dissolve the PO waste,
wherein
the purification method (D) is a purification method according to claim 13.

24. The method according to claim 23, wherein step (B) is carried out before step (C), or step (C) is carried out before step (B), or steps (B) and (C) are carried out simultaneously.
